(19) United States
(12) Patent Application Publication
(10) Pub. No.: US 2022/0293980 A1
(43) Pub. Date: Sep. 15, 2022

(54) FUEL CELL OVERHEATING PROTECTION SYSTEM AND METHOD

(71) Applicant: Ceres Intellectual Property Company Limited, Horsham West Sussex (GB)

(72) Inventor: Lei Sun, Weifang, Shandong (CN)

(21) Appl. No.: 17/635,293

(22) PCT Filed: Oct. 15, 2020
(86) PCT No.: PCT/IB2020/059680

§ 371 Date: Feb. 14, 2022

(30) Foreign Application Priority Data
Aug. 15, 2019 (CN) 201921330912.X

(51) Int. Cl. H01M 8/04664; H01M 8/0432; H01M 8/04014; H01M 8/04746

(52) U.S. Cl. CPC H01M 8/04686; H01M 8/04373; H01M 8/04022; H01M 8/04753

(57) ABSTRACT

A fuel cell overheating protection system and method. The system comprises a fuel gas isolation valve (1), a flow control unit (2), a combustor (3), a first controller (4), a second controller (5), a first temperature sensor (6), a second temperature sensor (7), a first switch K1 and a second switch K2. By utilizing the system, a fuel cell fault caused by overheat combustion can be effectively avoided.

### TECHNICAL FIELD

The present invention relates to the field of fuel cells, particularly to a fuel cell overheating protection system and method.

### BACKGROUND ART

In the combustion process of a fuel cell, if overheat combustion occurs, the fuel cell may fail. The so-called overheat combustion means that the temperature of the high temperature gas generated in the combustion process of the fuel is too high.

In view of this, there is a need for a solution that can avoid a fuel cell fault caused by overheat combustion.

### SUMMARY OF THE INVENTION

The present invention aims to avoid a fuel cell fault caused by overheat combustion and to provide a fuel cell overheating protection system.

A first aspect of the present application provides a fuel cell overheating protection system. The system comprises a fuel gas isolation valve (1), a flow control unit (2), a combustor (3), a first controller (4), a second controller (5), a first temperature sensor (6), a second temperature sensor (7), a first switch K1 and a second switch K2. The fuel gas isolation valve (1) is used to control the on/off state of a fuel gas pipeline; and the flow control unit (2) is used to control the supply volume of fuel gas. The combustor (3) is used to provide heat for fuel cell reaction based on a high temperature gas generated after ignition of the input fuel and air. The first temperature sensor (6) is used to connect the combustor (3) and to collect the temperature of the high temperature gas generated from combustion in the combustor (3). The second temperature sensor (7) is used to connect the combustor (3) and to collect the temperature of the high temperature gas generated from combustion in the combustor (3).

The first switch K1 and the second switch K2 are connected in series in a power circuit of the fuel gas isolation valve (1) and are used to control the power on/off state of the fuel gas isolation valve (1);

The first switch K1 and the second switch K2 are also connected in series in a power circuit of the flow control unit (2) and are used to control the power on/off state of the flow control unit (2);

The first controller (4) is used to connect the first temperature sensor (6) and is used to control the first switch K1 to be disconnected when the temperature detected by the first temperature sensor (6) is not lower than a preset temperature threshold;

The second controller (5) is used to connect the second temperature sensor (7) and is used to control the second switch K2 to be disconnected when the temperature detected by the second temperature sensor (7) is not lower than the preset temperature threshold.

A second aspect of the invention provides a fuel cell overheating protection method. The method comprises using the fuel gas isolation valve (1) to control the on/off state of a fuel gas pipeline; using the flow control unit (2) to control the supply volume of fuel gas; using the combustor (3) to provides heat for fuel cell reaction based on a high temperature gas generated after ignition of the input fuel and air; measuring the temperature of the high temperature gas generated from combustion in the combustor (3) with the first temperature sensor (6) connected to the combustor (3); measuring the temperature of the high temperature gas generated from combustion in the combustor (3) with the second temperature sensor (7) connected to the combustor (3); controlling the power on/off state of the fuel gas isolation valve (1) using the first switch K1 and the second switch K2 connected in series in a power circuit of the fuel gas isolation valve (1); controlling the power on/off state of the flow control unit (2) using the first switch K1 and the second switch K2 connected in series in a power circuit of the flow control unit (2); controlling the first switch K1 to be disconnected when the temperature detected by the first temperature sensor (6) is not lower than a preset temperature threshold using the first controller (4) connected to the first temperature sensor (6); and controlling the second switch K2 to be disconnected when the temperature detected by the second temperature sensor (7) is not lower than the preset temperature threshold using the second controller (5) connected to the second temperature sensor (7).

Optionally, the first switch K1 and the second switch are both relays.

Optionally, the first controller (4) is also used to connect the second controller (5) and is also used to send a first message to the second controller (5) after controlling the first switch K1 to be disconnected. The second controller (5) is also used to control the second switch K2 to be disconnected according to the first message when the temperature detected by the second temperature sensor (7) is lower than the preset temperature threshold.

Optionally, the second controller (5) is also used to determine that the second temperature sensor is faulty when the first message is received and the temperature detected by the second temperature sensor (7) is lower than the preset temperature threshold.

Optionally, the second controller (5) is also used to determine the first controller (4) or the first temperature sensor (6) is faulty when the first message is not received and the temperature detected by the second temperature sensor (7) is not lower than the preset temperature threshold.

Optionally, a signal connection or a hard-wired connection is adopted between the first controller (4) and the second controller (5).

An embodiment of the present invention provides a fuel cell overheating protection system. The system comprises a fuel gas isolation valve (1), a flow control unit (2), a combustor (3), a first controller (4), a second controller (5), a first temperature sensor (6), a second temperature sensor (7), a first switch K1 and a second switch K2. The fuel gas isolation valve (1) is used to control the on/off state of a fuel gas pipeline; and the flow control unit (2) is used to control the supply volume of fuel gas; the combustor (3) is used to provide heat for fuel cell reaction based on a high temperature gas generated after ignition of the input fuel and air; the first temperature sensor (6) is used to connect the combustor (3) and to collect the temperature of the high temperature gas generated from combustion in the combustor (3); the second temperature sensor (7) is used to connect the combustor (3) and to collect the temperature of the high temperature gas generated from combustion in the combustor (3); the first switch K1 and the second switch K2 are connected in series in a power circuit of the fuel gas isolation valve (1) and are used to control the power on/off state of the fuel gas isolation valve (1); the first switch K1 and the second switch K2 are also connected in series in a power circuit of the flow control unit (2) and are used to control the power on/off state of the flow control unit (2); the first controller (4) is used to connect the first temperature sensor (6) and is used to control the first switch K1 to be disconnected when the temperature detected by the first temperature sensor (6) is not lower than a preset temperature threshold; and the second controller (5) is used to connect the second temperature sensor (7) and is used to control the second switch K2 to be disconnected when the temperature detected by the second temperature sensor (7) is not lower than the preset temperature threshold.

Thus it can be seen that in an embodiment of the present invention, two temperature sensors (i.e., the first temperature sensor (6) and the second temperature sensor (7)) are used to collect the temperature of a high temperature gas generated from combustion in the combustor (3). Two switches (i.e., the first switch K1 and the second switch K2) are connected in series in the power circuit of the fuel gas isolation valve (1), and the first controller (4) can control the first switch K1 to be disconnected when the temperature detected by the first temperature sensor (6) is not lower than a preset temperature threshold; the second controller (5) can control the second switch K2 to be disconnected when the temperature detected by the second temperature sensor (7) is not lower than the preset temperature threshold. Thus it can be seen that in an embodiment of the present application, the first controller (4) and the second controller (5) both can control the power disconnection of the fuel gas isolation valve (1) and the power disconnection of the flow control unit (2) by controlling the on/off state of the switches corresponding to them when overheat combustion occurs, and as long as the first controller (4) and the second controller (5) are not faulty at the same time, the power disconnection of the fuel gas isolation valve (1) and the power disconnection of the flow control unit (2) can be effectively controlled. It is less likely that the first controller (4) and the second controller (5) are faulty at the same time. Therefore, by utilizing the system provided by the embodiment of the invention, a fuel cell fault caused by overheat combustion can be effectively avoided.

### BRIEF DESCRIPTION OF THE DRAWINGS

The drawings used in the description of the embodiments will be briefly described below. The drawings in the description below are just some embodiments of the present invention.

FIG. 1 is a structural schematic view of a fuel cell overheating protection system.

FIG. 2 is a structural schematic view of an alternative fuel cell overheating protection system.

### DETAILED DESCRIPTION

Embodiments of the present application will be described below in conjunction with the drawings. The described embodiments are only some, not all, of the embodiments of the present application.

The inventor found during research, that in the combustion process of a fuel cell, if overheat combustion occurs, the fuel cell may fail. The so-called overheat combustion means that the temperature of the high temperature gas generated in the combustion process of the fuel is too high. In the prior art, in case of overheat combustion, it can be solved by the second controller through adjustment of the supply volume of fuel gas. However, in this solution, once the second controller is faulty, the combustion of the combustor will lose control and a fuel cell fault caused by overheat combustion cannot be effectively avoided.

Embodiments of the present application provide a fuel cell overheating protection system to effectively avoid a fuel cell fault caused by overheat combustion.

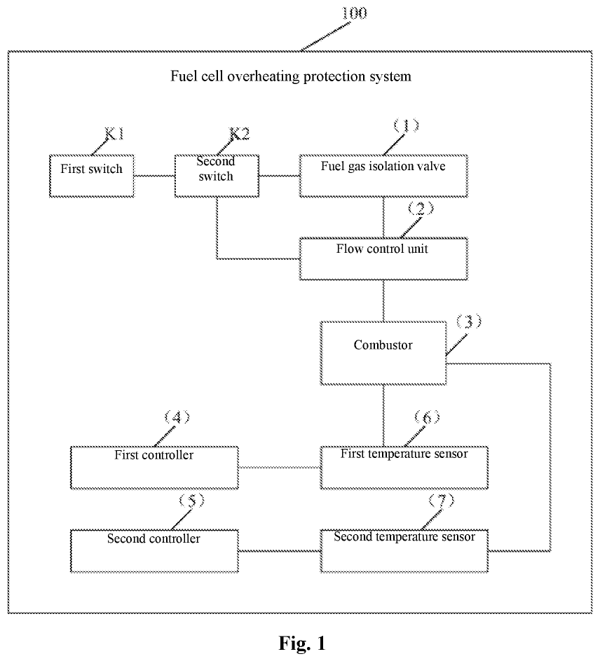

FIG. 1 is a structural schematic view of a fuel cell overheating protection system provided by an embodiment of the present invention. The fuel cell overheating protection system 100 provided by the embodiment of the present application may specifically comprise a fuel gas isolation valve (1), a flow control unit (2), a combustor (3), a first controller (4), a second controller (5), a first temperature sensor (6), a second temperature sensor (7), a first switch K1 and a second switch K2. The fuel gas isolation valve (1) is used to control the on/off state of a fuel gas pipeline; and the flow control unit (2) is used to control the supply volume of fuel gas. The combustor (3) is used to provide heat for fuel cell reaction based on a high temperature gas generated after ignition of the input fuel and air. The first temperature sensor (6) is used to connect the combustor (3) and to collect the temperature of the high temperature gas generated from combustion in the combustor (3). The second temperature sensor (7) is used to connect the combustor (3) and to collect the temperature of the high temperature gas generated from combustion in the combustor (3). The first switch K1 and the second switch K2 are connected in series in a power circuit of the fuel gas isolation valve (1) and are used to control the power on/off state of the fuel gas isolation valve (1).

When the first switch K1 is disconnected or the second switch K2 is disconnected, the fuel gas isolation valve (1) is powered off. The first switch K1 and the second switch K2 are also connected in series in a power circuit of the flow control unit (2) and are used to control the power on/off state of the flow control unit (2).

When the first switch K1 is disconnected or the second switch K2 is disconnected, the flow control unit (2) is powered off.

The first controller (4) is used to connect the first temperature sensor (6) and is used to control the first switch K1 to be disconnected when the temperature detected by the first temperature sensor (6) is not lower than a preset temperature threshold.

In the embodiment, if the temperature detected by the first temperature sensor (6) is not lower than a preset temperature threshold, it means the temperature of a high temperature gas generated in the combustor (3) is high and occurrence of overheat combustion can be considered. Therefore, the disconnection of the first switch K1 is controlled to cut off the power of the fuel gas isolation valve (1) and the power of the flow control unit (2). The preset temperature threshold can be determined according to the actual condition.

The second controller (5) is used to connect the second temperature sensor (7) and is used to control the second switch K2 to be disconnected when the temperature detected by the second temperature sensor (7) is not lower than the preset temperature threshold.

In this embodiment, if the temperature detected by the second temperature sensor (7) is not lower than a preset temperature threshold, it means the temperature of a high temperature gas generated in the combustor (3) is high and occurrence of overheat combustion can be considered. Therefore, the disconnection of the second switch K2 is controlled to cut off the power of the fuel gas isolation valve (1) and the power of The first switch K1 and the second switch K2 both can be relays. The above-mentioned control of disconnection of the first switch K1 can be control of disconnection of the normally closed contact of a first relay; accordingly, the above-mentioned control of disconnection of the second switch K2 can be control of disconnection of the normally closed contact of a second relay.

This embodiment does not specifically delimit the first controller (4) and the second controller (5). As an example, the first controller (4) can be a fuel cell controller, or Two temperature sensors (i.e., the first temperature sensor (6) and the second temperature sensor (7)) are used to collect the temperature of a high temperature gas generated from combustion in the combustor (3). Two switches (i.e., the first switch K1 and the second switch K2) are connected in series in the power circuit of the fuel gas isolation valve (1), and the first controller (4) can control the first switch K1 to be disconnected when the temperature detected by the first temperature sensor (6) is not lower than a preset temperature threshold; the second controller (5) can control the second switch K2 to be disconnected when the temperature detected by the second temperature sensor (7) is not lower than the preset temperature threshold. Thus it can be seen that in an embodiment of the present application, the first controller (4) and the second controller (5) both can control the power disconnection of the fuel gas isolation valve (1) and the power disconnection of the flow control unit (2) by controlling the on/off state of the switches corresponding to them when overheat combustion occurs, and as long as the first controller (4) and the second controller (5) are not faulty at the same time, the power disconnection of the fuel gas isolation valve (1) and the power disconnection of the flow control unit (2) can be effectively controlled. It is less likely that the first controller (4) and the second controller (5) are faulty at the same time. Therefore, by utilizing the system provided by the embodiment of the invention, a fuel cell fault caused by overheat combustion can be effectively avoided.

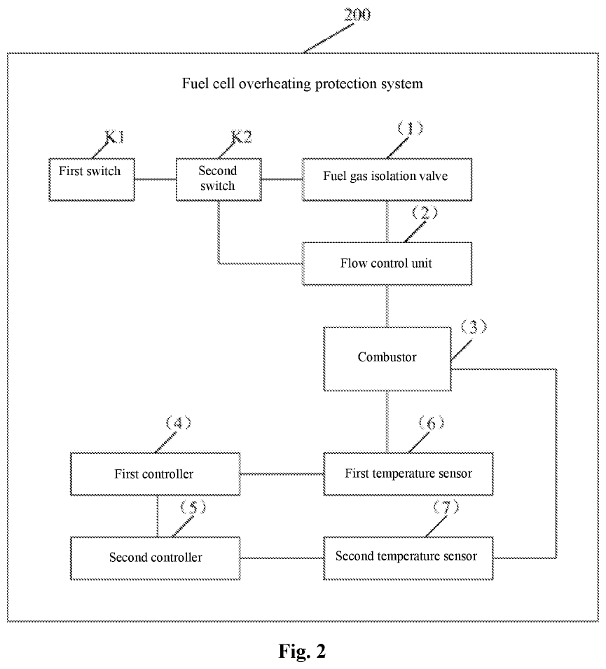

FIG. 2 is a structural schematic view of an alternative fuel cell overheating protection system provided by an embodiment of the present invention. In the fuel cell overheating protection system 200 shown in FIG. 2, the first controller (4) can also be connected to the second controller (5). The embodiment of the present application does not specifically delimit the connection method between the first controller (4) and the second controller (5), and a signal connection or a hard-wired connection can be adopted between the first controller (4) and the second controller (5).

After the first controller (4) controls the first switch K1 to be disconnected, the first controller (4) can also send a first message to the second controller (5); and the first message is used to inform the second controller (5) of possible overheat combustion. Considering that the second temperature sensor (7) may become faulty in the actual application, if the second controller (5) receives the first message, even if the temperature detected by the second temperature sensor (7) is lower than the preset temperature threshold, the second controller (5) may control the second switch K2 to be disconnected according to the first message in order to avoid a fuel cell fault caused by overheat combustion.

Although the first controller (4) has sent a control instruction of disconnection to the first switch K1 before the first controller (4) sends the first message to the second controller (5), if the first switch K1 is faulty, it is likely that the first switch K1 has not executed this control instruction of disconnection. For this reason, the second controller (5) may control the second switch K2 to be disconnected according to the first message to further improve the reliability of the system 100.

If the second controller (5) has received the first message and the temperature detected by the second temperature sensor (7) is lower than the preset temperature threshold, it is likely that the second temperature sensor (7) is faulty. It is also likely that the first temperature sensor is faulty, but in order to avoid a fuel cell fault caused by overheat combustion, under this circumstance, the second controller (5) can determine that the second temperature sensor (7) is faulty, thereby facilitating the maintenance personnel to troubleshoot the second temperature sensor (7).

Accordingly, if the second controller (5) does not receive the first message and the temperature detected by the second temperature sensor (7) is not lower than the preset temperature threshold, the second controller (5) determines the first controller (4) or the first temperature sensor (6) is faulty, thereby facilitating the maintenance personnel to troubleshoot the first controller (4) or the first temperature sensor (6).

Other implementations of the system and method of present application will be apparent. The present application intends to cover any such modifications, uses or changes of the present invention. The description and embodiments are exemplary only. The real scope of the present invention is stated in the following claims.

1. A fuel cell overheating protection system, comprising:
a fuel gas isolation valve,
a flow control unit,
a combustor,
a first controller,
a second controller,
a first temperature sensor,
a second temperature sensor,
a first switch, and
a second switch;
wherein:
the fuel gas isolation valve controls the on/off state of a fuel gas pipeline;
the flow control unit controls the supply volume of fuel gas;
the combustor provides heat for fuel cell reaction based on a high temperature gas generated after ignition of the input fuel and air;
the first temperature sensor is connected to the combustor and measures the temperature of the high temperature gas generated from combustion in the combustor;
the second temperature sensor is connected to the combustor and measures the temperature of the high temperature gas generated from combustion in the combustor;
the first switch and the second switch are connected in series in a power circuit of the fuel gas isolation valve to control the power on/off state of the fuel gas isolation valve;
the first switch and the second switch are also connected in series in a power circuit of the flow control unit to control the power on/off state of the flow control unit;
the first controller is connected to the first temperature sensor and controls the first switch to be disconnected when the temperature detected by the first temperature sensor is not lower than a preset temperature threshold; and
the second controller is connected to the second temperature sensor and controls the second switch to be disconnected when the temperature detected by the second temperature sensor is not lower than the preset temperature threshold.

2. The system according to claim 1, wherein the first switch and the second switch are both relays.

3. The system according to claim 1, wherein the first controller is connected to the second controller and is configured to send a first message to the second controller after controlling the first switch to be disconnected; and
the second controller controls the second switch to be disconnected according to the first message when the temperature detected by the second temperature sensor is lower than the preset temperature threshold.

4. The system according to claim 3, wherein the second controller determines that the second temperature sensor is faulty when the first message is received and the temperature detected by the second temperature sensor is lower than the preset temperature threshold.

5. The system according to claim 3, wherein the second controller determines that the first controller or the first temperature sensor is faulty when the first message is not received and the temperature detected by the second temperature sensor is not lower than the preset temperature threshold.

6. The system according to claim 3, wherein a signal connection or a hard-wired connection is adopted between the first controller and the second controller.

7. A fuel cell overheating protection method for use in system comprising:
a fuel gas isolation valve,
a flow control unit,
a combustor,
a first controller,
a second controller,
a first temperature sensor,
a second temperature sensor,
a first switch, and
a second switch;
wherein the method comprises:
using the fuel gas isolation valve to control the on/off state of a fuel gas pipeline;
using the flow control unit to control the supply volume of fuel gas;
using the combustor to provides heat for fuel cell reaction based on a high temperature gas generated after ignition of the input fuel and air;
measuring the temperature of the high temperature gas generated from combustion in the combustor with the first temperature sensor connected to the combustor;
measuring the temperature of the high temperature gas generated from combustion in the combustor with the second temperature sensor connected to the combustor;
controlling the power on/off state of the fuel gas isolation valve using the first switch and the second switch connected in series in a power circuit of the fuel gas isolation valve;
controlling the power on/off state of the flow control unit using the first switch and the second switch connected in series in a power circuit of the flow control unit;
controlling the first switch to be disconnected when the temperature detected by the first temperature sensor is not lower than a preset temperature threshold using the first controller connected to the first temperature sensor; and
controlling the second switch to be disconnected when the temperature detected by the second temperature sensor is not lower than the preset temperature threshold using the second controller connected to the second temperature sensor.

8. The method according to claim 7, wherein the first controller is connected to the second controller and sends a first message to the second controller after controlling the first switch to be disconnected; and
the second controller controls the second switch to be disconnected according to the first message when the temperature detected by the second temperature sensor is lower than the preset temperature threshold.

9. The method according to claim 8, wherein the second controller determines that the second temperature sensor is faulty when the first message is received and the temperature detected by the second temperature sensor is lower than the preset temperature threshold.

10. The method according to claim 8, wherein the second controller determines that the first controller or the first temperature sensor is faulty when the first message is not received and the temperature detected by the second temperature sensor is not lower than the preset temperature threshold.
